(19) United States
(12) Patent Application Publication
(10) Pub. No.: US 2023/0206111 A1
(43) Pub. Date: Jun. 29, 2023

(54) COMPOUND MODEL FOR EVENT-BASED PROGNOSTICS

(71) Applicant: Hitachi, Ltd., Tokyo (JP)

(72) Inventors: Mahbubul ALAM, San Jose, CA (US); Dipanjan GHOSH, Santa Clara, CA (US); Ahmed FARAHAT, Santa Clara, CA (US); Laleh JALALI, San Jose, CA (US); Chetan GUPTA, San Mateo, CA (US); Shuai Zheng, San Jose, CA (US)

(21) Appl. No.: 17/561,397

(22) Filed: Dec. 23, 2021

(51) Int. Cl. G06N 20/00

(52) U.S. Cl. CPC G06N 20/00

(57) ABSTRACT

Example implementations described herein can involve systems and methods involving, for receipt of input data from one or more assets, identifying and separating different event contexts from the input data; training a plurality of machine learning models for each of the different event contexts; selecting a best performing model from the plurality of machine learning models to form a compound model; selecting a best performing subset of the input data for the compound model based on maximizing a metric; and deploying the compound model for the selected subset.

### BACKGROUND

### Field

The present disclosure is generally directed to predictive maintenance systems, and more specifically, to a compound model for event-based prognostics.

### Related Art

Prognostics aims to predict the degradation of asset/equipment by estimating their remaining useful life (RUL) and/or the failure probability of asset/equipment within a specific time horizon. The high demand of equipment prognostics in the industry have propelled researchers to develop robust and efficient prognostics techniques. Among data driven techniques for prognostics, deep learning (DL) based techniques, particularly Recurrent Neural Networks (RNNs) have gained significant attention due to their ability of effectively representing the degradation progress by employing dynamic temporal behaviors. RNNs are well known for handling sequential data, especially continuous time series sequential data where the data follows certain pattern. Such data is usually obtained from sensors attached to the equipment/assets.

However, in many scenarios, sensor data may not be readily available and can often be very tedious to acquire. Conversely, event data is more common and can easily be obtained from the error logs saved by the equipment/assets. Nevertheless, performing prognostics using event data can be substantially more difficult than that of the sensor data due to the unique nature of event data. Though event data is sequential, it differs from other seminal sequential data such as time series and natural language in the following manner, i) unlike time series data, events may appear at any time, i.e., the appearance of events lacks periodicity; ii) unlike natural languages, event data do not follow any specific linguistic rule. In addition, there may be a significant variability in the event types appearing within the same sequence. Given there are hundreds of event types each preceded by a different pattern of events, it can be very difficult for a single machine learning (ML) or DL model to capture the underlying pattern from the complex event data.

Due to the high demand and profitability in the industry, researchers have proposed several solutions for the prognostics problem in the past few decades. Many of these solutions utilize continuous time series data obtained from the sensors attached to the equipment/asset. These sensors continuously or periodically record machine health information which is later utilized to design a solution for the prognostics task problem. However, in many practical industry scenarios, such well recorded sensor data may be unavailable and can be very difficult to obtain in a short time. Conversely, event data can be more commonly available and easier to obtain. Nevertheless, prognostics from event data is challenging since event data lacks periodicity and does not follow any generic rule. Therefore, the data driven solutions designed for sensor and event data may require fundamentally different frameworks.

The prognostics task may be solved using mathematical models which directly ties to the underlying physical processes. The mathematical models can be broadly categorized as i) Knowledge based, ii) Traditional ML based, and iii) Deep Learning (DL) based. Knowledge-based approaches utilize a priori expert knowledge and deductive reasoning processes for fault diagnosis and prognostics. Knowledge based approaches can be summarized with the following three techniques, a) Ontology-based, b) Rule-based and c) Model-based. Among these, Model-based techniques have shown some reasonable promise which involve fault diagnosis and prognostics using models such as linear system models, proportional hazards model, exponential models, Gaussian process-based models, and so on. These models are utilized to solve maintenance problem in various components such as gear boxes, bearings, rotors, lithium-ion batteries, and so on. Even though knowledge-based model shows promise, the lack of reasoning, difficulty of generalizing for new faults, and too many mathematical assumptions make such models difficult to use for solving more complex and real-life prognostics problems. Consequently, early ML based techniques such as Artificial Neural Networks (ANN), decision tree (DT), Support Vector Machine (SVM), k-Nearest Neighbors (k-NN), principle component analysis (PCA), self-organizing maps (SOMs), and so on are introduced to tackle more complex prognostics problems.

Example problems that have been solved by using traditional ML-based methods include prognostics of machinery systems and power systems, bearing performance degradation, wind turbine structures, and so on. Succinctly, traditional ML-based models solve more complex prognostics problems and show improved performance when compared to the knowledge-based approaches. Nevertheless, related art ML-based techniques struggle when the data size increases exponentially, and the problem becomes gradually more complex. As such, deep learning (DL) based methods are hailed for handling intricate prognostics problems using big data.

Deep learning models have the unique ability of automatically extracting features from the input data while solving the task at hand. Moreover, DL models achieve state-of-the-art performance in many different industry applications including prognostics. The most popular DL models utilized for solving prognostics tasks are Convolutional Neural Networks (CNNs), Auto-encoders, Recurrent Neural Networks (RNNs), Long Short Term Memory (LSTMs), Deep Belief Networks (DBNs), Generative Adversarial Networks (GANs), and so on. These models solve a variety of prognostics tasks such as bearing performance degradation, fault prognostics of battery systems, rotating machineries, wind turbine systems etc. Furthermore, advanced DL methods such as Deep Reinforcement Learning (DRL), Transfer Learning, and Domain Adaptation techniques are explored for solving complex prognostics tasks such as health indicator learning (HIL) problem, using existing solution for solving prognostics problem in a different domain with limited labeled data. While the above-mentioned DL models achieve notable performance improvement compared to that of the related art ML based systems, the DL models are tested on similar type of continuous time series data such as bearing systems, battery health data, rotating machinery data, and wind-turbine data. Therefore, these related art methods may not be suitable for handling more challenging event data which lacks periodicity and do not follow any pre-defined rule or pattern.

There are few related art implementations that utilize event data for solving a specific prognostics task. However, such related art methods have the following limitations: they are tested on very simple event data which follows some pre-defined rules, sensor data is used with event data, they use rule-based methods or simple ML methods such as shallow artificial neural network (ANN) and principal component analysis (PCA) which are very difficult to generalize.

### SUMMARY

In example implementations described herein, a compound model architecture for event-based prognostics is systematically designed that not only achieves improved performance compared to any standalone ML or DL techniques, but also provides a generalized framework for solving any prognostics problem that involves event data. Consequently, example implementations described herein involve a novel “event specific compound model” technique to solve the prognostics task using event data.

Example implementations described herein involve compound ML models designed to capture the dynamic nature of the events for solving the prognostics task. As mentioned above, it can be very difficult to capture the underlying patterns using a single model from the sequences involve multiple event types. Therefore, example implementations first disentangle the data based on some event context. The context may be defined by the type of the event, impact of the event, attribute of the equipment from which the event is captured, and so on. The context may also be defined by a domain expert or may depend on the nature of the application. Next, the example implementations train multiple ML models for each subset separated based on the event context. The intuition behind training multiple models is to capture different relationship between the events learned by different ML models.

Among these ML models, one model may capture better event relationship than others, and hence, example implementations propose a greedy and a learning-based approach for selecting the best model that maximizes the overall prognostics task performance. Essentially, the example implementations segment the data based on some event context, learn multiple ML models and select one ML model for each segment. However, in many practical scenarios the best model may fail to achieve satisfactory performance for some of the events due to lack of training data or presence of significant noise in the data. Especially, in critical applications such as operations and maintenance, model false positives cause substantial downtime and economic loss. To alleviate this problem, example implementations involve a data driven approach for selecting the subset of data for which the model should be applied to ensure consistently high accuracy of the model. This in turn ensures user confidence on the deployed prognostics model. Finally, the selected subset of data may be considered for deployment in the field.

In summary, example implementations involve the learning of multiple ML models for each event context, selecting best model from the learned models for each event context to form a compound model, and performing data sub-setting to obtain consistent high model accuracy.

Aspects of the present disclosure can involve a method, which can include, for receipt of input data from one or more assets, identifying and separating different event contexts from the input data; training a plurality of machine learning models for each of the different event contexts; selecting a best performing model from the plurality of machine learning models to form a compound model; selecting a best performing subset of the input data for the compound model based on maximizing a metric; and deploying the compound model for the selected subset.

Aspects of the present disclosure can involve a computer program, storing instructions which can include, for receipt of input data from one or more assets, identifying and separating different event contexts from the input data; training a plurality of machine learning models for each of the different event contexts; selecting a best performing model from the plurality of machine learning models to form a compound model; selecting a best performing subset of the input data for the compound model based on maximizing a metric; and deploying the compound model for the selected subset. The computer program can be stored in a non-transitory computer readable medium for execution by one or more processors.

Aspects of the present disclosure can involve a computer program, storing instructions which can include, for receipt of input data from one or more assets, identifying and separating different event contexts from the input data; training a plurality of machine learning models for each of the different event contexts; selecting a best performing model from the plurality of machine learning models to form a compound model; selecting a best performing subset of the input data for the compound model based on maximizing a metric; and deploying the compound model for the selected subset. The computer program can be stored in a non-transitory computer readable medium for execution by one or more processors.

Aspects of the present disclosure can involve a system, which can include, for receipt of input data from one or more assets, means for identifying and separating different event contexts from the input data; means for training a plurality of machine learning models for each of the different event contexts; means for selecting a best performing model from the plurality of machine learning models to form a compound model; means for selecting a best performing subset of the input data for the compound model based on maximizing a metric; and means for deploying the compound model for the selected subset.

Aspects of the present disclosure can involve an apparatus, which can include, a processor, configured to for receipt of input data from one or more assets, identify and separate different event contexts from the input data; train a plurality of machine learning models for each of the different event contexts; select a best performing model from the plurality of machine learning models to form a compound model; select a best performing subset of the input data for the compound model based on maximizing a metric; and deploy the compound model for the selected subset.

### BRIEF DESCRIPTION OF DRAWINGS

FIG. 1 illustrates a high-level flow diagram of the proposed event-based prognostics using the compound model, in accordance with an example implementation.

FIG. 2 illustrates an example of data-preprocessing for the event-based prognostics task, in accordance with an example implementation.

FIG. 3 illustrates an example data sub-setting process based on event context, in accordance with an example implementation.

FIG. 4 illustrates the procedure for training T ML/DL models for each subset, in accordance with an example implementation.

FIG. 5 illustrates an example of the greedy based model selection process, in accordance with an example implementation.

FIG. 6 illustrates the learning-based approach, in accordance with an example implementation.

FIG. 7 illustrates an example data sub-setting technique for identifying the best performing subset of the data in accordance with an example implementation.

FIG. 8 shows the event-based compound model framework for client input request and output response, in accordance with an example implementation.

FIG. 9 illustrates a system involving a plurality of assets networked to a management apparatus, in accordance with an example implementation.

FIG. 10 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve an event specific compound model for event prognostics such as failure prediction and remaining useful life, The example implementations described herein are directed to the building/designing of models for events. Events may occur in a sequential manner, wherein one sequence may contain multiple events. Such events are very difficult for a model to capture the behavior of all these events with just one single model. Example implementations described herein design models for each individual event and then a determination is made as to which model is appropriate for each event through a best model selection from compound models. Example implementations train a plurality of different models for one specific event, which will provide a plurality of different outputs, however, only one model is needed to provide the physical form. The models are combined into a compound model by a technique such as greedy/rule based algorithms or by learning based algorithms.

Example implementations also select a subset of events for which the model maximizes a performance metric (e.g., accuracy), the metric selected based on the desired implementation. The sequential events are derived based on the OEM implementation of the asset which utilizes the underlying data to determine the events. The data can be in the form of time series data or natural language data depending on the underlying asset. The sequence of events can involve duplicate events that can reappear at any time. Such events may also be associated with features to describe the event in accordance with the desired implementation (e.g., error codes, specific indicators, etc.) that can be extracted in accordance with the desired implementation.

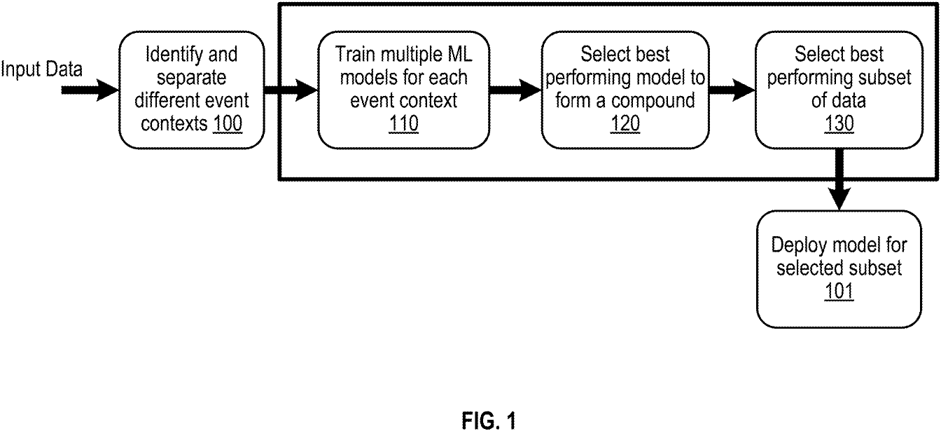

FIG. 1 illustrates a high-level flow diagram of the proposed event-based prognostics using the compound model, in accordance with an example implementation. In the example flow as illustrated in FIG. 1, the input data is preprocessed to identify and separate different event contexts at 100. The preprocessed data is provided to the proposed compound model for event-based prognostics, for which multiple ML models are trained for each context at 110, the best performing model is selected to form a compound model at 120, and the best performing subset of data is also selected at 130. Once selected, the model and subset are deployed at 101.

As follows, the compound model for event-based prognostics is described herein. Firstly, event specific models are designed for prognostics. Secondly, the best performing model for each event is identified, and lastly, an efficient data sub-setting technique is used to maintain consistent high model accuracy. Before explaining each of aspects of the example implementations, the event-based prognostics problem is formally defined as follows.

To define the problem, let, X = [X₁, X₂, X₃, ...,Xₙ] be an event dataset, where Xᵢ = [xᵢ₁,x_{i2,}xᵢ₃,...,x_{im.}] is a data instance contains a collection of un-correlated sequential events obtained from a pool of equipment/asset. Each xᵢₖ represents a specific event type. Please note that both repetition and reappearance of any event xᵢₖ is allowed, i.e., x_{11,} x_{11,} x₁₂ and X₁₁, x₁₂, x₁₁ are both valid sequence of events. Also, events from any instance of X may appear in other instances(s), i.e., x₁₁, x₂₁, x₃₂ is a valid sequence. These sequential events may appear at any point of time without following any specific pattern or periodicity. Example events may include fault codes, error codes or any predefined codes that carry a meaning for that event. A collection of these codes collected from different equipment in the same domain and organized in a historical fashion form an event dataset. Such dataset may be obtained from a database that collects all the information captured by the device attached to the equipment. Additionally, each event xᵢₖ may contain optional information oᵢₖ which appear along with the event. Therefore, by definition oᵢₖ is sequential and expressed as Oᵢ = [oᵢ₁, oᵢ₂, oᵢ₃, ..., oᵢₘ] where oᵢₖ may be a single value or a collection of multiple values tied to the event. Example optional information may include the time of the event occurrence, the part number which is affected by the event, and so on. Moreover, each equipment/asset of interest may have some unique static attributes expressed as C = {c₁, c₂, c₃,..., c_{q}}. Example static attributes may include equipment manufacturer, model number, year, subcategory etc. Finally, the event-based prognostics problem can be defined as follows. Given, the input [X, O, C] for an equipment, estimate failure time of the equipment Y = [Y₁,Y₂, Y₃, ..., Yₙ] where, Yᵢ = {yᵢ₁, yᵢ₂, yᵢ₃, ..., yᵢₘ} and yᵢ₁ ≥ yᵢ₂ ≥ yᵢ₃ ≥ ... ≥ yᵢₘ. The following equation formally defines the event-based prognostics problem,

$$Y - f \left(X , O , C\right)$$

where, f is a function that performs prognostics.

For the data pre-processing, from a machine learning context, the event-based prognostics problem can be posed as either regression or classification task. Accordingly, example implementations process the input and output data to fit the regression or classification problem. The input data in our event-based prognostics problem formulation contains both sequential and static variables. These variables can be represented by either numerical or categorical values. Numerical values are processed with optional normalization technique. Categorical values are processed using appropriate category to numeric mapping technique. The sequential event data is converted in a “1-step increment” fashion and considers the corresponding target value of the last event in the 1-incremented sequence as the output. This transformation of the input converts the many-to-many mapping problem to a many-to-one problem. Additionally, the number of instances increase significantly which is beneficial when limited training samples are present.

Optional pre-processing of the event sequences may be applied by keeping only the first appearance of an event ignoring the consecutive repetition of that event. This optional repeated event occurrence dropping step depends on the application and may require domain expert confirmation. For example, a sequence x₁₁, x₁₁ , x₁₂ is converted to x₁₁, x₁₂. However, for x₁₁, x₁₂, x₁₁, no changes are made as the repetition of x₁₁ is not consecutive. Subsequently, the target/output of the corresponding repeated event is removed. In this example, when the input x₁₁, x₁₁, x₁₂ is converted to x₁₁, x₁₂, the corresponding output of the second x₁₁ is removed, i.e., the output y₁, y₂, y₃ becomes y₁, y₃.

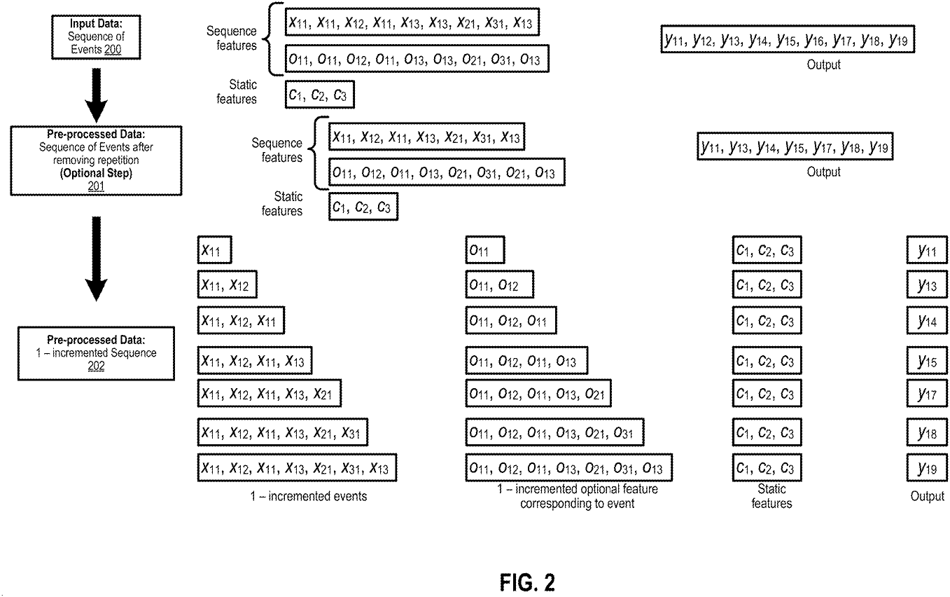

FIG. 2 illustrates an example of data-preprocessing for the event-based prognostics task, in accordance with an example implementation. Specifically, FIG. 2 further illustrates the input and output data pre-processing for the event-based prognostics task for the following example which is an instance from one row of X: input: [(x₁₁, x₁₁, x₁₂, x₁₁, x₁₃, x₁₃, x₂₁, x₃₁, x₁₃),(o₁₁, o₁₁, o₁₂, o₁₁, o₁₃, o₁₃, o₂₁, o₃₁, o₁₃) , (c₁, c₂, c₃)] and target/output: [(y₁₁, y₁₂, y₁₃, y₁₄, y₁₅, y₁₆, y₁₇, y₁₈, y₁₉)].

As illustrated in FIG. 2, there are three aspects in the data-preprocessing. At first, the input data involves the sequence of events at 200. At 201, pre-processing is done to remove repetitions of events from the input data. Depending on the desired implementation, this step can be omitted. At 202, the pre-processed data are provided as 1-incremented sequences.

Example implementations described herein involve three aspects as described below in detail. In a first aspect, there is the learning of multiple ML models for each event context. The first step for building the event-specific compound model is to subset the dataset X based on some event context and/or equipment attributes. As such, the dataset X is separated into subsets X_{x̅ᵤ} based on the event context where, u = 1, 2, 3, ..., r and x̅ represents the context definition.

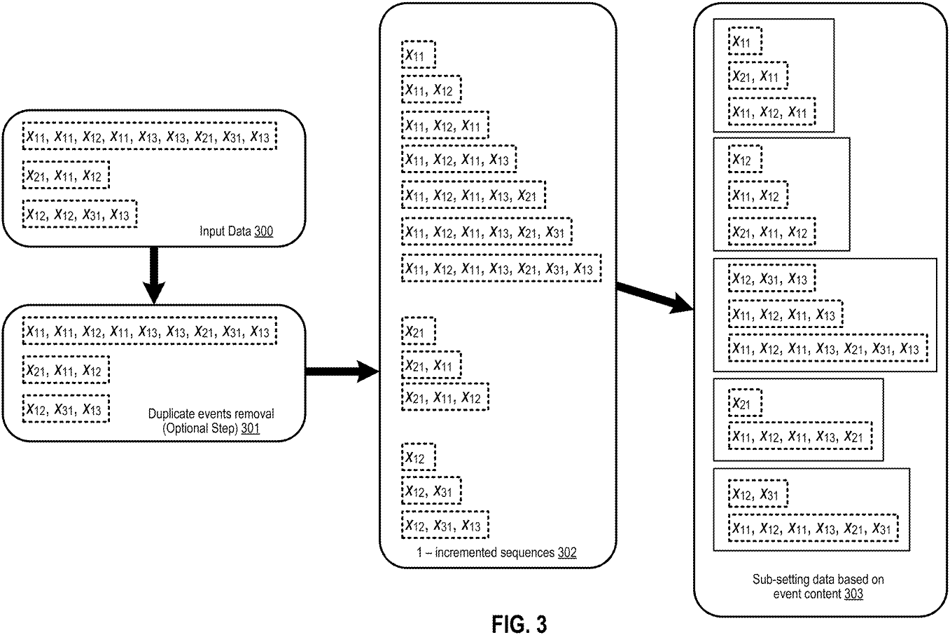

FIG. 3 illustrates an example data sub-setting process based on event context, in accordance with an example implementation. For input data 300, input O and C are ignored for simplicity of visualization. The input O is processed following the reformation performed in X as shown at 301 to 303 to conduct the duplicate events removal, organization into 1-incremented sequences, and forming data subsets based on event content. No further pre-processing is required for the input C.

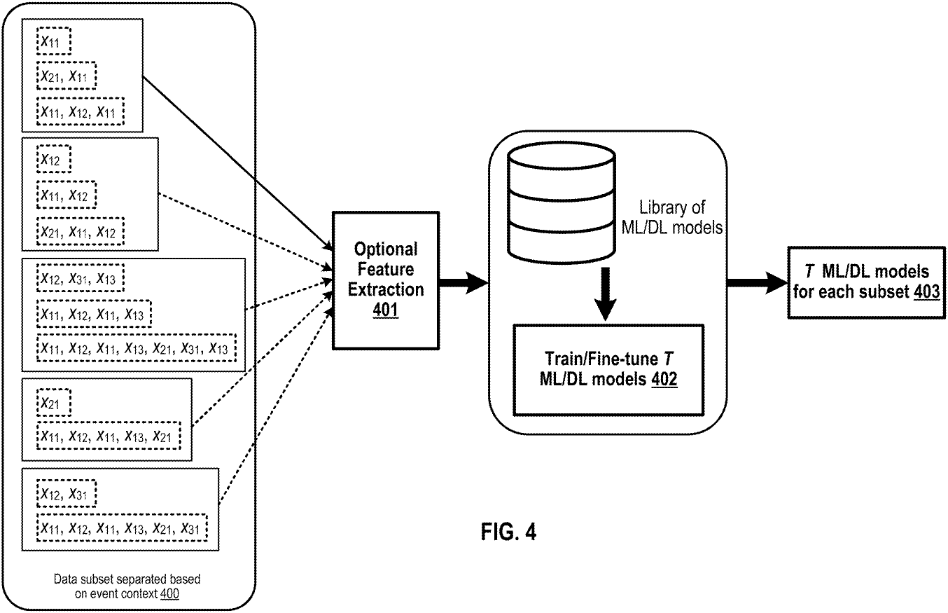

FIG. 4 illustrates the procedure for training T ML/DL models for each subset, in accordance with an example implementation. Subsequently, multiple ML and/or DL models are trained for each subset X_{x̅ᵤ} to obtain the compound model. T ML and/or DL models are trained from a library of pre-existing ML/DL models. The ML/DL models may also be trained using an automated system such as Auto-ML. Each subset X_{x̅ᵤ} is provided as input to all the ML/DL models separately at 400. An optional feature extraction step may be necessary for the traditional ML models such as support vector machine (SVM), XGBoost, and so on, and is conducted at 401. Subsequently, the ML/DL models are trained or fine-tuned using the current data subset for solving the prognostics task at 402. Essentially, the automated model selection system works as a black box where it takes the subsets X_{x̅ᵤ} as input and outputs the T ML/DL models for each subset at 403.

In a second aspect, there is the selection of the best model to form the compound model. This step proposes two techniques for choosing the subset specific best model from the T models. The best model selection is necessary to obtain one prediction from each record of the test data with the ambition to improve the overall test accuracy. The two techniques are, i) Greedy based approach and ii) Learning based approach, to perform the model selection task using a validation set

$${X}_{{{x}^{⃛}}_{u}}^{v}$$

separated from the training set

$${X}_{{{x}^{⃛}}_{u}} .$$

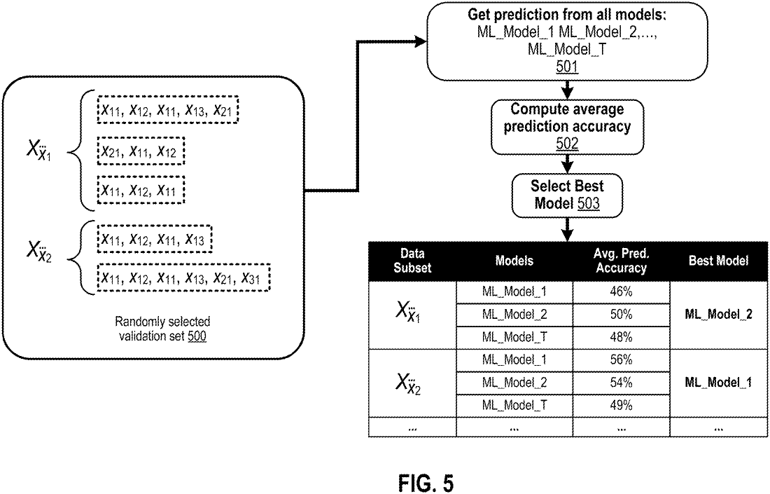

FIG. 5 illustrates an example of the greedy based model selection process, in accordance with an example implementation. In the greedy based approach, the validation set

$${X}_{{{x}^{⃛}}_{u}}^{v}$$

is used to get predictions from all the T models and average prediction accuracy is obtained. Example implementations select the model that gives the best average prediction accuracy. At 500, a validation set is randomly selected. At 501, the prediction is obtained from all of the models. At 502, the average prediction accuracy of each of the models is determined. At 503, the best model is selected from the models for each of the subsets and is maintained as management information as illustrated in the table of FIG. 5.

Although the greedy based model selection process is simple, a change in the distribution of the test data from the

$${X}_{{{x}^{⃛}}_{u}}^{v}$$

validation data may negatively impact the overall test accuracy. To alleviate this, the example implementations can also utilize a learning-based model selection technique in accordance with the desired implementation.

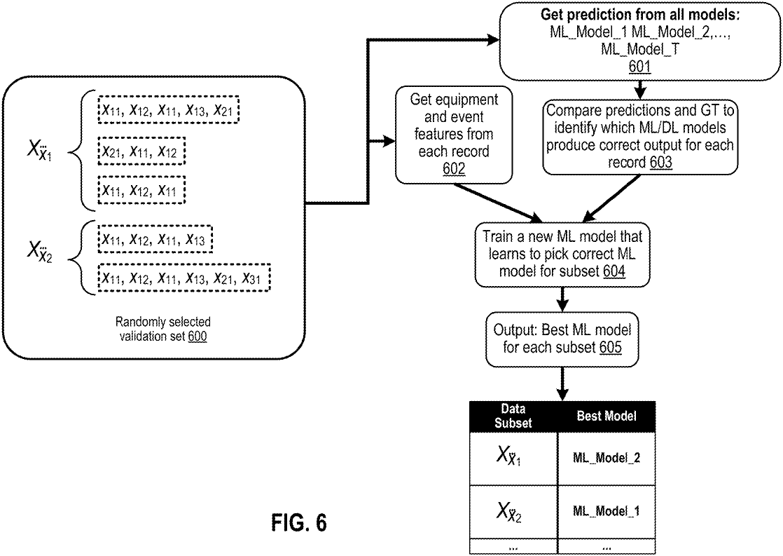

FIG. 6 illustrates the learning-based approach, in accordance with an example implementation. At 600, the validation sets are randomly selected. In the learning-based approach, certain features are extracted from the events and the equipment associated with the events at 602. Next at 601, predictions from all the T models are obtained using the validation set

$${X}_{{{x}^{⃛}}_{u}}^{v} .$$

These predictions and the corresponding ground truths are used to identify the ML/DL models that produce the correct predictions at 603. The correct and incorrect values corresponding to ML/DL models are converted to binary labels. Finally, the event features and the binary labels are utilized to train a new ML model at 604 for selecting a single model from the T models for each validation set at 605. This learning-based method may reduce the test data distribution change issue.

In a third aspect, there is data sub-setting for consistent high model accuracy. The best model selected in the previous step may fail to show satisfactory accuracy for some events due to lack of training data or noticeable noise in the training data. Maintaining consistent high accuracy and low false positive rates may be essential for critical applications such as healthcare and high-maintenance cost industrial sector. As such, obtaining a subset of the data for which the model shows steady high accuracy is an important and challenging problem in the industry.

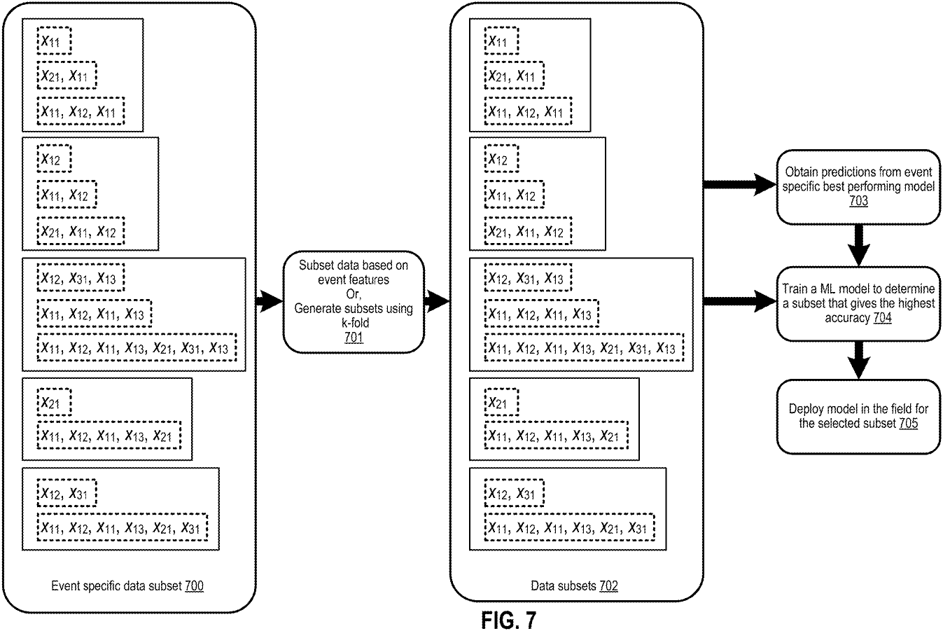

FIG. 7 illustrates an example data sub-setting technique for identifying the best performing subset of the data in accordance with an example implementation. To achieve this, once the event specific data subset is received at 700, the input data X is subset based on some event features and features obtained from the equipment of interest at 701 to generate data subsets at 702. Alternatively, the sub-setting can be performed in k-fold fashion where k is an integer number. Please note that the sub-setting technique explained herein is completely independent from the above descriptions. Using the subset along with the predictions and ground truths obtained from the previous sub-section from 703, example implementations train a ML model to determine a subset of data points that achieves the highest accuracy at 704. The selected subset of data points is then considered for deployment of the proposed compound model in the field at 705. This ensures ML model reliability by producing consistent high accuracy for certain events.

The data sub-setting steps are summarized as follows. First, predictions are obtained from all the training and validation samples using the compound model as described in the second aspect. These predictions are used to generate the binary labels to train the new binary classifier. For each sample, 1 is assigned if the prediction matches with the ground truth, otherwise, 0 is assigned. Some event features and equipment attributes are considered as the input to the new classifier. Using these input features, the binary labels and the training data, a binary classifier is trained where the output of the model is prediction probability of each class. There may be multiple combinations of event features and equipment attributes in which case separate ML models are trained for each combination.

Next, the validation data is passed through the newly trained ML models to obtain the prediction probabilities. Finally, the portion of records which gives an overall prediction accuracy greater than certain threshold are selected wherein the portion of records cover a predefined percentage of validation data. The threshold and the predefined percentage may be defined by the domain expert or tuned based on the data. Though the data-setting technique is utilized for maximizing accuracy for the event-based prognostics problem, such a technique may be applied in any critical applications before actual deployment of the model in the field, in accordance with the desired implementation.

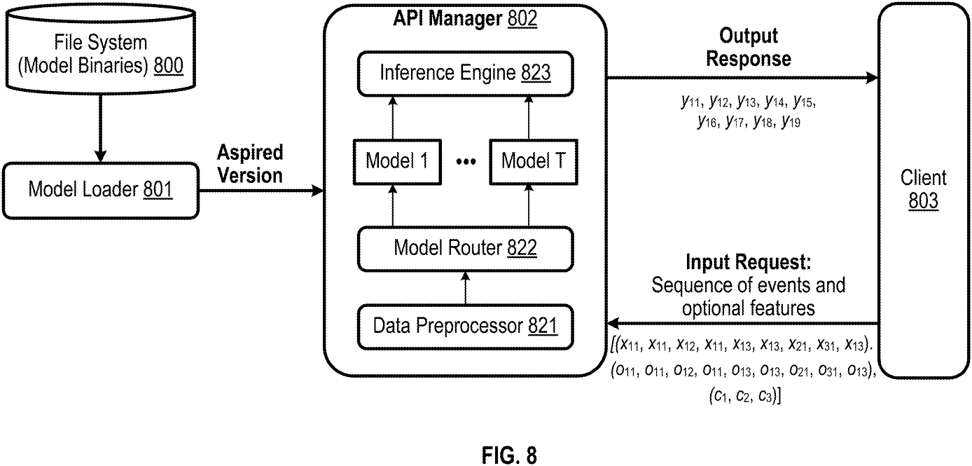

FIG. 8 shows the event-based compound model framework for client input request and output response, in accordance with an example implementation. First, the client 803 provides the following input to the framework: a sequence of events along with optional sequence features and static features to the API manager 802. Next, the API manager 802 takes the input and performs the following sequence of operations, i) all the event specific best model binaries 800 obtained using the method mentioned above are loaded from the file system into the memory by the model loader 801, ii) the input provided by the client is pre-processed using the techniques described herein by data preprocessor 821, iii) based on the data subset in hand, the model router module routes the data to the appropriate model as described in model router 822, iv) the inference engine 823 uses the selected model to obtain the output, and v) the output response is presented to the client in terms of remaining time to fail. Consequently, the client analyzes the outcome to take necessary actions for preventing unexpected failure of the equipment/asset. It is worth mentioning that the event-based compound model framework is carefully designed to deliver the desired output response with minimal client involvement.

Example implementations described herein involve event-based compound model which may be used in any industry for predictive maintenance of equipment or assets. In high maintenance cost industry applications, either reactive or preventive maintenance may incur huge expenses. To alleviate this, sensors can be installed in the equipment to obtain operation data for training a predictive maintenance model such as prognostics. However, sensor installation for data acquisition is a difficult and cumbersome task. On the other hand, recording events occurred during the operation period of an equipment before failure is both easy and cost effective. However, prognostics from event data is inherently daunting. Therefore, the proposed event-based compound model technique may be used as an efficient and cost-effective solution for solving the prognostic s task in any industry that maintains equipment and asset.

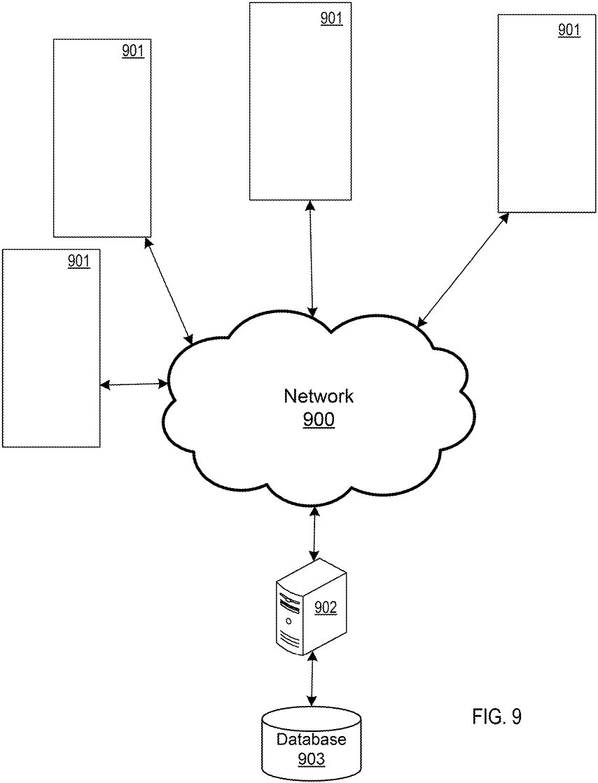

FIG. 9 illustrates a system involving a plurality of assets networked to a management apparatus, in accordance with an example implementation. One or more assets 901 are communicatively coupled to a network 900 (e.g., local area network (LAN), wide area network (WAN)) through the corresponding on-board computer or Internet of Things (IoT) device of the assets 901, which is connected to a management apparatus 902. The management apparatus 902 manages a database 903, which contains historical data collected from the assets 901 and also facilitates remote control to each of the assets 901. In alternate example implementations, the data from the assets can be stored to a central repository or central database such as proprietary databases that intake data, or systems such as enterprise resource planning systems, and the management apparatus 902 can access or retrieve the data from the central repository or central database 903. Assets 901 can involve any physical asset in accordance with the desired implementation, such as but not limited to air compressors, lathes, coolers, trucks, and so on in accordance with the desired implementation. Assets can involve sensors (e.g., vibration sensors, etc.), and can provide the sequential events to the management apparatus 902 based on the sensor data based on the underlying OEM implementation of the asset.

Depending on the desired implementation, the definition of the events can be provided based on the underlying OEM implementation of the assets, and/or can be managed in the database 903 and defined in accordance with the desired implementation (e.g., via domain expertise).

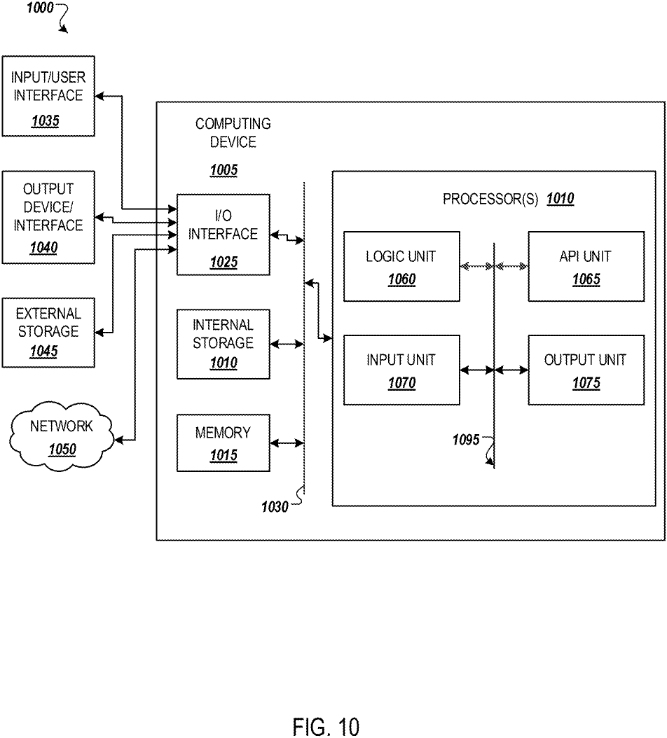

FIG. 10 illustrates an example computing environment with an example computer device suitable for use in some example implementations, such as a management apparatus 902 as illustrated in FIG. 9, or as an on-board computer of an asset 901. Computer device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and/or I/O interface 1025, any of which can be coupled on a communication mechanism or bus 1030 for communicating information or embedded in the computer device 1005. I/O interface 1025 is also configured to receive images from cameras or provide images to projectors or displays, depending on the desired implementation.

Computer device 1005 can be communicatively coupled to input/user interface 1035 and output device/interface 1040. Either one or both of input/user interface 1035 and output device/interface 1040 can be a wired or wireless interface and can be detachable. Input/user interface 1035 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1040 may include a display, television, monitor, printer, speaker, braille, or the like. In some example implementations, input/user interface 1035 and output device/interface 1040 can be embedded with or physically coupled to the computer device 1005. In other example implementations, other computer devices may function as or provide the functions of input/user interface 1035 and output device/interface 1040 for a computer device 1005.

Examples of computer device 1005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1005 can be communicatively coupled (e.g., via I/O interface 1025) to external storage 1045 and network 1050 for communicating with any number of networked components, devices, and systems, including one or more computer devices of the same or different configuration. Computer device 1005 or any connected computer device can be functioning as, providing services of: or referred to as a server, client, thin server, general machine, special-purpose machine, or another label.

I/O interface 1025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computer device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1010 can execute under any operating system (OS) (not shown), in a native or virtual environment. One or more applications can be deployed that include logic unit 1060, application programming interface (API) unit 1065, input unit 1070, output unit 1075, and inter-unit communication mechanism 1095 for the different units to communicate with each other, with the OS, and with other applications (not shown). The described units and elements can be varied in design, function, configuration, or implementation and are not limited to the descriptions provided. Processor(s) 1010 can be in the form of hardware processors such as central processing units (CPUs) or in a combination of hardware and software units.

In some example implementations, when information or an execution instruction is received by API unit 1065, it may be communicated to one or more other units (e.g., logic unit 1060, input unit 1070, output unit 1075). In some instances, logic unit 1060 may be configured to control the information flow among the units and direct the services provided by API unit 1065, input unit 1070, output unit 1075, in some example implementations described above. For example, the flow of one or more processes or implementations may be controlled by logic unit 1060 alone or in conjunction with API unit 1065. The input unit 1070 may be configured to obtain input for the calculations described in the example implementations, and the output unit 1075 may be configured to provide output based on the calculations described in example implementations.

Processor(s) 1010 can be configured to load instructions from memory 1015 to execute a process, which can involve, for receipt of input data from one or more assets, identifying and separating different event contexts from the input data 100; training a plurality of machine learning models for each of the different event contexts 110; selecting a best performing model from the plurality of machine learning models to form a compound model 120; selecting a best performing subset of the input data for the compound model based on maximizing a metric 130; and deploying the compound model for the selected subset 101 as illustrated in FIG. 1.

Processor(s) 1010 can be configured to load instructions from memory 1015 to further execute a process involving executing data preprocessing on the input data, the data preprocessing involving separating different events in the input data into one-step incremented event subsets; and forming each of the different event contexts from subsets of the one-step incremented event subsets as illustrated at 202 of FIG. 2 and 302 and 303 of FIG. 3.

Processor(s) 1010 can be configured to execute the process for training the plurality of machine learning models for each of the different event contexts by training machine learning models for each of the subsets of the one-step incremented event subsets as illustrated in FIGS. 4 to 7.

Processor(s) 1010 can be configured to execute the process for selecting the best performing model from the plurality of machine learning models to form the compound mode 1 based on comparison of the plurality of models to a ground truth as illustrated in FIG. 7.

Processor(s) 1010 can be configured to execute the process for selecting the best performing model from the plurality of machine learning models to form the compound model based on an average metric as illustrated in FIG. 5. The average metric can involve accuracy or other metrics in accordance with the desired implementation.

Depending on the desired implementation, the compound model can be configured to output event prognostics based on another input data from a client. Such event prognostics can involve failure prediction, remaining useful life (RUL) as described in FIG. 8.

Depending on the desired implementation, the input data from the one or more assets is indicative of sequential events obtained from the one or more assets as illustrated in 200 and 300 of FIG. 2 and FIG. 3, respectively.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of input data from one or more assets:
identifying and separating different event contexts from the input data;
training a plurality of machine learning models for each of the different event contexts;
selecting a best performing model from the plurality of machine learning models to form a compound model;
selecting a best performing subset of the input data for the compound model based on maximizing a metric; and
deploying the compound model for the selected subset.

2. The method of claim 1, further comprising executing data preprocessing on the input data, the data preprocessing comprising:
separating different events in the input data into one-step incremented event subsets; and
forming each of the different event contexts from subsets of the one-step incremented event subsets.

3. The method of claim 2, wherein the training the plurality of machine learning models for each of the different event contexts comprises training machine learning models for each of the subsets of the one-step incremented event subsets.

4. The method of claim 1, wherein the selecting the best performing model from the plurality of machine learning models to form the compound model is based on comparison of the plurality of models to a ground truth.

5. The method of claim 1, wherein the selecting the best performing model from the plurality of machine learning models to form the compound model is based on an average metric.

6. The method of claim 1, wherein the compound model is configured to output event prognostics based on another input data from a client.

7. The method of claim 1, wherein the input data from the one or more assets is indicative of sequential events obtained from the one or more assets.

8. A non-transitory computer readable medium, storing instructions for executing a process, the instructions comprising:
for receipt of input data from one or more assets:
identifying and separating different event contexts from the input data;
training a plurality of machine learning models for each of the different event contexts;
selecting a best performing model from the plurality of machine learning models to form a compound model;
selecting a best performing subset of the input data for the compound model based on maximizing a metric; and
deploying the compound model for the selected subset.

9. The non-transitory computer readable medium of claim 8, the instructions further comprising executing data preprocessing on the input data, the data preprocessing comprising:
separating different events in the input data into one-step incremented event subsets; and
forming each of the different event contexts from subsets of the one-step incremented event subsets.

10. The non-transitory computer readable medium of claim 9, wherein the training the plurality of machine learning models for each of the different event contexts comprises training machine learning models for each of the subsets of the one-step incremented event subsets.

11. The non-transitory computer readable medium of claim 8, wherein the selecting the best performing model from the plurality of machine learning models to form the compound model is based on comparison of the plurality of models to a ground truth.

12. The non-transitory computer readable medium of claim 8, wherein the selecting the best performing model from the plurality of machine learning models to form the compound model is based on an average metric.

13. The non-transitory computer readable medium of claim 8, wherein the compound model is configured to output event prognostics based on another input data from a client.

14. The non-transitory computer readable medium of claim 8, wherein the input data from the one or more assets is indicative of sequential events obtained from the one or more assets.

15. An apparatus, comprising:
a processor, configured to:
for receipt of input data from one or more assets:
identify and separate different event contexts from the input data;
train a plurality of machine learning models for each of the different event contexts;
select a best performing model from the plurality of machine learning models to form a compound model;
select a best performing subset of the input data for the compound model based on maximizing a metric; and
deploy the compound model for the selected subset.
